(19) United States
(12) Patent Application Publication
(10) Pub. No.: US 2022/0222610 A1
(43) Pub. Date: Jul. 14, 2022

(54) Unified Tracking System

(71) Applicant: Hall Labs LLC, Provo, UT (US)

(72) Inventors: David R. Hall, Provo, UT (US); Jared Eggett, Lehi, UT (US); David Brent Noel, Orem, UT (US)

(73) Assignee: Hall Labs LLC, Provo, UT (US)

(21) Appl. No.: 17/146,364

(22) Filed: Jan. 11, 2021

(51) Int. Cl. G06Q 10/08

(52) U.S. Cl. CPC G06Q 10/087

(57) ABSTRACT

A unified tracking system is disclosed. The unified tracking system tracks items by adding a first block to a first blockchain associated with a first item, adding a second block a second blockchain associated with a second item, identifying a first value for an attribute associated with the first item based on an association with the second item, adding a third block to the second blockchain, wherein the third block includes the first value for the attribute of the first item and a reference to a block in the first blockchain, and adding a fourth block to the first blockchain, wherein the fourth block includes the first value for the attribute of the first item and a reference to a block in the second blockchain.

### CROSS-REFERENCE TO RELATED APPLICATIONS

The present application for patent claims priority to U.S. Provisional Application No. 62/959,341, filed Jan. 10, 2020, which is assigned to the assignee of the present application and hereby expressly incorporated by reference

### TECHNICAL FIELD

The described systems, devices, and methods are directed to tracking items and properties of items.

### BACKGROUND

It is estimated that 1.2-3% of all goods are lost to shrinkage (e.g., inventory shrinkage, shrink). Shrinkage generally refers to the loss of goods between manufacture and sale. In today's global economy, shrinkage has huge economic impacts and represents billions of dollars of loss annually. Shrinkage factors include theft (e.g., employee theft, shoplifting), spoilage, damage, misplacement, poor product traceability for recalls, technician assembly errors, administrative errors, and the like. Accordingly, solutions are needed to reduce shrinkage.

### SUMMARY

In a first aspect, the disclosure describes a method for tracking items. The method includes adding a first block to a first blockchain associated with a first item; adding a second block a second blockchain associated with a second item; identifying a first value for an attribute associated with the first item based on an association with the second item; adding a third block to the second blockchain, wherein the third block includes the first value for the attribute of the first item and a reference to a block in the first blockchain; and adding a fourth block to the first blockchain, wherein the fourth block includes the first value for the attribute of the first item and a reference to a block in the second blockchain.

In a second aspect, the disclosure provides that the block in the second blockchain is the third block, and wherein the block in the first blockchain is the fourth block.

In a third aspect, the disclosure provides that the method further includes adding a fifth block a third blockchain associated with a third item; identifying a second value for the attribute associated with the item based on an association with the third item; adding a sixth block to the third blockchain, wherein the sixth block includes the second value for the attribute of the first item and a reference to a block in the first blockchain; and adding a seventh block to the first blockchain, wherein the seventh block includes the seventh value for the attribute of the first item and a reference to a block in the third blockchain.

In a fourth aspect, the disclosure provides that the method further includes determining a difference between the second value for the attribute and the first value for the attribute; triggering an alert when the difference between the second value for the attribute and the first value for the attribute exceeds a threshold; and adding an eighth block to the first blockchain, wherein the eighth block includes information about the alert.

In a fifth aspect, the disclosure provides that the fourth block includes a first timestamp for the first value and that the seventh block includes a second timestamp for the second value, and that the second timestamp is after the first timestamp.

In a sixth aspect, the disclosure provides that the fourth block includes a reference to the first block, and that the third block includes a reference to the second block.

In a seventh aspect, the disclosure provides that the item is a product, a piece of equipment, a raw material, an action, a person, or a document.

In an eighth aspect, the disclosure provides that the attribute is a weight, a size, a location, a temperature, a duration, a status, an event, a transaction, or a financial parameter.

In a ninth aspect, the disclosure provides that the method includes identifying the first item based on a first identifying code associated with the first item; and identifying the second item based on a second identifying code associated with the second item.

In a tenth aspect, the disclosure provides that the first identifying code and the second identifying code are electronically identified from an image captured by a camera.

In an eleventh aspect, the disclosure describes a device for tracking items. The device includes a processor; memory in electronic communication with the processor; and instructions stored in the memory that when executed by the processor cause the processor to: add a first block to a first blockchain associated with a first item; add a second block a second blockchain associated with a second item; identify a first value for an attribute associated with the first item based on an association with the second item; add a third block to the second blockchain, wherein the third block includes the first value for the attribute of the first item and a reference to a block in the first blockchain; and add a fourth block to the first blockchain, wherein the fourth block includes the first value for the attribute of the first item and a reference to a block in the second blockchain.

In a twelfth aspect, the disclosure provides that the block in the second blockchain is the third block, and that the block in the first blockchain is the fourth block.

In a thirteenth aspect, the disclosure provides that the instructions are further executable by the processor to: add a fifth block a third blockchain associated with a third item; identify a second value for the attribute associated with the item based on an association with the third item; add a sixth block to the third blockchain, wherein the sixth block includes the second value for the attribute of the first item and a reference to a block in the first blockchain; and add a seventh block to the first blockchain, wherein the seventh block includes the seventh value for the attribute of the first item and a reference to a block in the third blockchain.

In a fourteenth aspect, the disclosure provides that the instructions are further executable by the processor to: determine a difference between the second value for the attribute and the first value for the attribute; trigger an alert when the difference between the second value for the attribute and the first value for the attribute exceeds a threshold; and add an eighth block to the first blockchain, wherein the eighth block includes information about the alert.

In a fifteenth aspect, the disclosure provides that the fourth block includes a first timestamp for the first value and that the seventh block includes a second timestamp for the second value, and that the second timestamp is after the first timestamp.

In a sixteenth aspect, the disclosure provides that the fourth block includes a reference to the first block, and that the third block includes a reference to the second block.

In a seventeenth aspect, the disclosure provides that the item is one of a product, a piece of equipment, a raw material, an action, a person, and a document.

In an eighteenth aspect, the disclosure provides that the attribute is a weight, a size, a location, a temperature, a duration, a status, an event, a transaction, or a financial parameter.

In a nineteenth aspect, the disclosure provides that the instructions are further executable by the processor to: identify the first item based on a first identifying code associated with the first item; and identify the second item based on a second identifying code associated with the second item.

In a twentieth aspect, the disclosure provides that the first identifying code and the second identifying code are electronically identified from an image captured by a camera.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed systems, devices, and methods and are not intended to show every potential feature or embodiment of the claimed systems, devices, and methods. The drawings are not necessarily drawn to scale; in some instances, certain elements of the drawing may be enlarged with respect to other elements of the drawing for purposes of illustration.

FIG. 1 is a perspective diagram illustrating an embodiment in which the described systems and methods may be used.

FIG. 2 is a block diagram illustrating a blockchain that may be used in the described systems and methods.

FIG. 3 is a block diagram illustrating an embodiment illustrating automated quantity determination.

FIG. 4 is a perspective diagram illustrating a safety lockout hasp that utilizes the described systems and methods.

FIG. 5 is a block diagram of a computing device for implementing the described systems and methods.

FIG. 6 is a flow diagram illustrating one example of a method for tracking items.

### DETAILED DESCRIPTION

The following description recites various aspects and embodiments of the systems, devices, and methods disclosed herein. No particular embodiment is intended to define the scope of the described systems, devices, and methods. Rather, the embodiments provide non-limiting examples of various compositions, and methods that are included within the scope of the claimed systems, devices, and methods. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As noted above, shrinkage is a substantial problem. Shrinkage is due to multiple factors. The largest factor is typically theft (e.g., employee theft, shoplifting). Whether by an employee (that has access to the inventory, for example) or a non-employee (that has access to the inventory, for example), in the case of theft, goods literally disappear (i.e., are stolen) prior to sale.

Spoilage results from time sensitive products (e.g., food items, car seats, batteries, etc.) being held too long, such that their usable life has expired or changed to the point that the value of the goods has been impacted. This is a high value problem because an item may go from full value to zero value simply with that passage of time.

Damage is the result of goods being exposed to environmental factors that change the look, feel, or usability, or perceived quality of the goods. Examples of environmental factors that can cause damage include drops, breaks, crush forces, tip overs, temperature swings, water, sunlight, etc. Common damage can be the result of poor handling, such as drops or crush impacts to goods.

Administrative errors include mismatches between quantities ordered (or invoiced) compared with quantities delivered, tracking errors (e.g., lack of tracking, errors in tracking, generic tracking, etc.), placement errors (e.g., misplacement), and the like.

While shrinkage is the result of multiple factors including employee theft, non-employee theft (e.g., shoplifting), administrative errors, spoilage, and damage, better tracking systems appear to be a primary solution (perhaps the only solution, for example) needed to curb (e.g., substantially reduce and/or eliminate) shrinkage.

One of the challenges associated with distributed supply chains (e.g., supply chains that traverse multiple disparate entities (e.g., companies)) is that each entity typically uses their own tracking system, which breaks tracking continuity between entities. Another challenge associated with distributed supply chains is that tracking the relationships between raw materials and finished goods becomes difficult, if not impossible, across multiple companies, each with their own tracking systems that are configured for their internal uses. Accordingly, an improved tracking system would be beneficial.

The described systems, devices, and methods relates to a unified tracking system (e.g., transparency of an item's lifetime) with accessible (e.g., public) records that enable different entities to access the records. In some embodiments, the accessible records may be blocks in a chain of blocks that uses blockchain technology (each block includes a hash of the block and a hash the previous block, for example). The accessible records may be decentralized and distributed requiring consensus to ensure data security. In some cases, blocks are cryptographically secure to ensure only authorized users can access the data. Because blockchain ensures data is not tampered with, a permanent record may be easily maintained using blockchain technology.

In one example a new blockchain is established for each unique item. An item may be a physical item (e.g., a raw material, a component, a finished good, a piece of equipment, a fixture), a person (e.g., an individual, a worker, a technician), a document (e.g., a contract, an invoice, an email, an instruction), and the like.

With the unified tracking system, all the entities may (or may not) utilize the same tracking system. At the point at which the unified tracking system is used, the item block (e.g., genesis block, first block in the chain of blocks) is created. Thereafter the item is tracked with each interaction being added as a new block in the block chain. Accordingly, the block chain captures a transparency of an item's lifetime (experience of events, actions, interactions (e.g., with processes and/or people), assembly, sourcing, destination, packaging, transportation, locations, quality tests, repairs, usage, etc., for example)

For example, a pallet of a raw material may be received from a first entity (that does not utilize the unified tracking system, for example). At the unloading dock, the pallet may be affixed with a first label (e.g., a barcode, matrix barcode, Quick Response (QR) code, radio frequency identification (RFID), or the like) and scanned into the unified tracking system. A new block chain is created for the first label (representing the pallet), with the first block identifying what the item is (i.e., a pallet of the raw material) and a first action (e.g., received by the entity at a particular facility). In some embodiments, a jack that is used to move the pallet may weigh the pallet to provide an initial weight of the pallet. In some embodiments, a camera or camera system (or lidar system, for example) may be used to identify an initial physical size of the pallet. These additional parameters may be included in the first block or in a subsequent block in the chain (depending on implementation and/or timing of when each action (e.g., receipt, weighing, identifying dimension, etc.) occurs). The weight and/or dimension of the pallet may be used to identify the quantity of raw material in the pallet. These measurements may be used in combination to help detect alterations or tampering with the pallet.

Continuing with this example, at some point at least a portion of the pallet may be opened/disassembled. Regardless of how the pallet is broken up (e.g., in individual boxes of one, in smaller quantities (e.g., 12), or larger boxes that each contain smaller boxes, with individual boxes inside the smaller boxes), each disparate item is labeled with a unique label associated with a unique block chain, as discussed with respect to the first label. Each unique blockchain includes a reference to the blockchain associated with the pallet. In addition, the blockchain associated with the pallet may be updated (in one or more subsequent blocks, for example) with a reference to the action of removing of an item from the pallet, a reference to the person (e.g., worker) or persons who is doing the removing, and a listing of each unique label for each disparate item. In this way, each interaction is permanently tracked in a simple manner that allows easy tracking of each step/interaction along the way for each item.

It is appreciated that the tracking system creates lots of different block chains (e.g., one for each item). For example, a block chain for the pallet may contain information about the pallet, equipment or fixtures that have interacted with the pallet, persons that have interacted with the pallet, actions that have been performed on the pallet, etc. Each of these, in turn, may have their own block chains that track information, interactions, and the like. For example, the person that breaks a part the pallet may be identified with the action of breaking a part the pallet. In this case, a box may be added to each of the involved items to the interaction/transaction. For example, a block may be added to the blockchain for the pallet (indicating the action of breaking apart, the person(s) doing the breaking, and the resulting labels of the subparts, for example), a block (e.g., the genesis block, first block) may be added to the blockchain for the disparate item (indicating the action of being unloaded from the pallet with a reference to the pallet, the person doing the unloading, the location of the action, etc., for example), a block may be added to the blockchain for the person (indicating the action was performed by the person, when the action was performed, how many of those actions the blockchain was formed, for example), and a block may be added to the action indicating that the action was done, when the action was done, and by whom (e.g., the person) the action was done.

Each label may contain a reference to the particular blockchain associated with the item that the label is on. In addition, the each label may contain additional information associated with the item. For example, the label on the pallet may include a reference to the blockchain as well as additional information, such as a quantity associated with the item, a location of the item, an owner of the item, and/or the like. Accordingly, in the case that only a portion of the pallet was removed from the pallet, then the pallet may be rewrapped, and a second label may be added to the pallet to replace the first label. In some embodiments, the second label may identify the same block chain for the pallet along with new information identifying the new quantity of raw material in the pallet (along with weight and/or dimension information, for example). In another embodiment, a new blockchain may be created for the partial pallet with a reference to the blockchain for the pallet associated with the first label. In either case, the unified tracking system enables detailed tracking (e.g., transparency of the item's lifetime) that encompasses data about the item, data about what fixtures/equipment the item went through, data about the persons that interacted with the item, and data about the actions/activity that the item went through. In some embodiments, a location can be an item and have a unique blockchain or may be an attribute of an item and be listed and/or updated in a blockchain associated with that item. Furthermore, the data from the unified tracking system may be accessible by all entities in a supply chain or potentially anyone who has any interested in seeing it.

It is appreciated that the permanent record allows simple references between blocks in the same or different blockchains to identify relationships, interactions, or connections. For example, group/subgroup relationships can easily have multiple layers with each level documented by references to upper level and lower-level relationships (via references (e.g., parent/child) to related blocks, for example).

The described features herein may be used in combination with virtual/augmented/mixed reality glasses to improve and enhance workflows. As noted above, virtual/augmented/mixed reality glasses may be equipped with one or more cameras that provide images that can be analyzed to monitor items, monitor locations, update locations, etc. In some embodiments the virtual reality system may use the cameras and the resulting information that comes from a viewed label to enhance or augment a job. Alternatively, digital content may be dynamically displayed on a device (e.g., display, monitor, mobile device, phone, tablet, etc.).

For example, a person may be completing a job that requires assembly of multiple parts and the virtual/augmented/mixed reality display may automatically display an instructional video and/or assembly video based on the step that the person is doing. The step that the person is doing may be determined based on an item that the person is manipulating (the label attached to the item that the person is manipulating, for example).

In one example, a person may be carrying out a lock-out tag-out operation and different labels may trigger instructional videos for properly performing the lock-out tag-out operation may be displayed on the virtual/augmented/mixed reality display. In addition, a label may trigger cameras on the virtual/augmented/mixed reality display to capture video clips of the lock-out tag-out procedure that can be reviewed by a manager to verify compliance. For example, the virtual/augmented/mixed reality glasses may provide instructions for each step of lock-out and tag-out and may capture an image or vide of each completed step of lock-out, tag-out. The virtual/augmented/mixed reality glasses may capture a label associated with the person at the time of putting the virtual/augmented/mixed reality glasses on, may capture a label of the piece of equipment that the lock-out, tag-out operation is being performed on, may capture a label indicating an action of lock-out, tag-out (which may trigger the instructional videos, for example) and may create new entries in the block chains for each of the piece of equipment, the action, and the person identifying the person as the person completing the lock-out, tag-out operation (including clips of the completed steps, for example), and details about time, location, and duration of the lock-out, tag-out operation, etc. as desired in the various blockchains.

In some embodiments, including the lock out tag out example, a label (e.g., QR code) may be split in half, with each half being on a different items (e.g., two pieced forming a buckle, a piece of equipment and a lock out tag, etc.) such that the label can only be read when the different items are fixed appropriately (as required by lock out tag out, for example). In this way, the tracking system may automatically determine if a step (e.g., such as a lock out tag out step) is properly completed, based on the readability of the label that becomes readable when multiple pieces (e.g., two halves, three thirds, etc.) are properly configured.

In the case of a warehouse, items (e.g., pallets, boxes, bins, sacks, etc.) are moved around using equipment (e.g., a forklift, pallet jack, conveyor, etc.). A piece of equipment may weigh the item during operation of the equipment. For example, a forklift may determine a weight of a pallet as it picks up, moves, and/or sets down the pallet. The equipment may communicate the weight of the item to a server that may add the weight as an attribute to the blockchain associated with the item. In the case that the item already included a weight attribute, an algorithm may determine if the current weight of the item corresponds with the prior weight of the item. If the weight of the item corresponds to the prior weight (as determined from the blockchain associated with the item, for example), then a server (e.g., algorithm) may determine that everything is fine with the item. In other words, nothing has been taken away (e.g., via theft or damage) from the item and/or nothing has been added (e.g., foreign objects, water, etc.) to the item. If a difference between a current weight and a prior weight exceeds a set threshold then the item may be flagged as needing attention (e.g., having an error/problem). In some embodiments, a block that identifies the current weight, a time, a location associated with the weight measure, an activity associated with the weight measure, and the like, may be added to the blockchain associated with the item, to the blockchain associated with the equipment, and to the activity that is being carried out when the weight measure is being carried out.

The equipment may communicate the weight measure as well as additional information for addition to one or more blockchains via a wireless communication protocol (e.g., Bluetooth, Wi-Fi). A difference between a prior weight and a current weight may indicate theft, damage, or problems with an item. Accordingly, a trigger (based on exceeding the set threshold) may send an alert and/or trigger an alarm. As discussed above, weight on its own, and in combination with other factors provides important information about an item, including whether the item has changed (e.g., in weight). In general, items in a warehouse should maintain a constant weight unless there are problems with the item. Accordingly, discreet weight measurements as the item is moved may allow for determination of a time for when the change was detected as well as the location where the item was located when the change occurs. All of this information may be added to the blockchain associated with the item, providing a continuing record associated with the item.

Similar to weight, the size and/or shape configuration of an item (e.g., a pallet) should not change, except during certain actions (such as when a pallet is unpacked and items are removed from the pallet, for example). Typically, pallets are wrapped with plastic as a final step of palletization. Other items (other than pallets, for example) may similarly be wrapped with plastic for protection during warehousing and shipment to an end consumer.

Regardless of the item, the plastic operation includes a rotation of the item and/or a rotation of the plastic wrapping equipment around the item. In some embodiments, the plastic wrapping equipment may include one or more imaging devices (e.g., camera, lidar, etc.) that capture/determines a three-dimensional (3D) model of the item. This 3D model of the item may be added (in a block, for example) to the blockchain of the item.

While the initial plastic wrapping operation provides an ideal situation for 3D modeling and size/dimension determination, it is appreciated that capturing at least three different images from different angles may also provide the information needed to effectively 3D model the item. These images may come from one camera that captures multiple images as the item moves (e.g., changes perspective in the frame of the image) or may come from multiple cameras at different angles.

Once the initial 3D model and/or size/shape configuration/dimensions of the item are determined then future 3D modeling measurements may be taken and compared with the prior size/shape/dimensions as a check/verification to ensure that the item has not changed in size/shape/dimensions. This comparison of dimensions may be performed easily by comparing size/dimensions information from the prior size/dimensions (as contained in a first block in the blockchain of the item, for example) with the current size/dimensions (as contained in a subsequent block in the blockchain of the item, for example) Like with weight, the size/shape/dimensions of an item should remain constant during most activities (e.g., storage, transport, etc.). If a difference in the size/dimensions of the item exceeds a set threshold, then an alert is triggered, and the item is flagged as having a potential error/problem.

In some embodiments, size/shape/dimensions of an item may be obtained based on a camera located on a user or a fork truck that is passing by the item. Doing a size/dimensions check may catch damage and or theft (e.g., by a person taking something from a pallet) automatically as cameras pass by the item.

Blockchains have nearly unlimited capacity (depending on the size of the addressing system of blocks, for example). Accordingly, the blockchain may include blocks that contain and/or track all kinds of information and/or attributes. These attributes include an item identifier (ID) (e.g., asset ID, for asset tagging purposes), a responsible party for the item, depreciation information (e.g., for accounting purposes), natural aging attributes (e.g., expiration dates, sell by dates, etc.), sales data, transaction data, weight, size/dimensions, actions performed on, timestamps of actions and or events, location, quality control information and testing information, sourcing information, and the like.

As noted herein, the blockchain may be accessible to multiple entities (may be public or restricted to those with access, for example) and may be used by multiple entities as items are transferred between and in custody of different entities. Accordingly, the detailed history and experience of each item may be precisely tracked. It is appreciated that this information may be used to improve inventory/warehouse management while reducing shrinkage.

Due to human limitations, items (e.g., boxes and pallets) are typically limited to a single item type. The unified tracking system easily maintains detailed records of each item within a pallet or a box, allowing for mixed bundles of items.

In one example, a top (first) level item (e.g., a pallet) may have a first label, each of a number of boxes within the pallet may each have a second level unique second label (regardless of whether the boxes include the same item or a mixed bundle of items, each box is uniquely identified and tracked, for example). Each box may include sub boxes which may each have a third level unique third label (regardless of whether the sub boxes include the same item or a mixed bundle of items, each sub box is uniquely identified and tracked, for example). It is appreciated that each item (e.g., pallet, boxes, and sub boxes) may each be recognized as a unique item (as well as the items in the sub boxes, for example) and may have a unique blockchain associated with the item.

As there is a hierarchy of items, each item may include in its block chain its relationship to both top level and bottom level items (e.g., the blockchain for the pallet may identify each relationship in the hierarchy, including the second labels of each box included in the pallet as well the third labels of each sub box contained within their respective boxes (and the items within the respective sub boxes, for example). Similarly, each item (each box, sub box, and item, and additional layers as needed, for example) may include similar relationship records in their respective blockchains. Thus, a lowest label item can trace relationships all the way to a specific pallet (and higher, for example). Similarly, the top-level item (e.g., the pallet) can trace relationship all the way down to each specific lowest label item. Accordingly, relationships and tracking are uniquely maintained in the unified tracking system. It is appreciated that the blockchain and multi entity availability of the unified tracking system allows entities to leverage prior information and data to enhance metrics associated with each item and draw observations and conclusions based on the available big data.

Activities are also items and may be tracked as discussed herein. Activities may be defined in a multitude of ways. Example of activities include, receiving an item, moving an item to a location, shipping an item, unpacking an item, packing items into a new item, performing maintenance on an item, quality checking/testing an item, depreciating an item, conducting a financial transaction regarding the item, etc. Each activity may have its own blockchain and with a new block being added, potentially for each activity that occurs. This detailed tracking may provide insights on how, when, where different activities are performed and even track how those activities impact items.

Documents are also items and may be tracked as discussed herein. Documents include all sorts of documents, including contracts, instructions (readable, video, audio, etc.), reports, checklists (e.g., assembly checklists, regulatory checklists), PowerPoint documents, individual files, photos, videos, audio clips, and the like. By tracking user interaction and/or activities (see activities above, e.g., reading, viewing, signing, delivering, transacting, invoicing, billing, paying, approving, verifying, completing, etc.) that occur with the documents.

Persons are also items and may be tracked as discussed herein. Person tracking may allow easy references (by referencing the person's blockchain or a block in the persons blockchain, for example) between things, activities, documents, and the people interacting with each of these items.

This tracking and recording of interactions that occurs between any kind of items and across all items (e.g., equipment, goods, activities, documents, persons, and the like). For example, as described herein, an action such as quality assurance check of an item by a person using a piece of equipment may result in entries in the blockchain for each of these items (e.g., an entry in the item blockchain, the activity blockchain, the person blockchain, and the equipment blockchain). While this amount of data may be large, the division and usability of the data is enhanced because trends such as comparison of accuracy/failure rates on one piece of equipment vs another piece of equipment or a comparison of accuracy/failure rates of one person performing quality assurance vs. another person performing the same quality assurance.

By using passive cameras and strategically located labels (such as a camera on a person, a label for the person, a label for the piece of equipment, a label for the activity, and a label for the specific item) may allow for all of the tracking data to be collected without any interaction of the person (the tracking occurs passively with respect to persons, for example). In some embodiments, a person's gloves may include labels to specifically identify the person associated with the glove and the exact item that the person is grabbing with the glove. The rich data trail may be used to identify trends that may be used to improve and/or optimize processes.

The additional granularity of knowing what items the person (e.g., the labeled glove) is grabbing/using may allow for additional checks and verifications/approvals. For example, a set of rules can be enforced to ensure that certain items (e.g., tools, forklifts) can only be used by authorized users. For instance, warnings can be issued if the wrench being used is the wrong size for the task being performed, and the like. Additionally, or alternatively, detailed tracking can be performed on what items are used at what times and for how long. In the case of a medical surgery, a complete list of items (e.g., tools, supplies, etc.) that was used or is available for use may be tracked. Algorithms to check whether a particular device should be used (e.g., has a recall on it, or was flagged as previously having a defect) can be performed in the background and allow for alerts to be made (to the surgeon or nurses, for example) regarding usage of certain items. In some cases, knowing the exact devices that were used during a surgery may be beneficial for identifying trends, tracking outcomes, and even defending against malpractice claims.

A camera may passively capture images and make quantity determinations based on labels seen in the images. In a first embodiment a box or bin may include one or more labels that are covered by an item when an item is in the box or bin and is visible when the item is removed. Accordingly, quantity detection may be based on which label or labels are visible in an image. In another embodiment, quantity may be determined based on labels that are visible when an item is in the box or bin and not visible when the item is removed from the box or bin. Accordingly, quantity detection may be based on which label or labels are no longer visible in an image. In both of these examples, a camera may be placed directly above or pointed at a box or bin to properly observe the visible/not visible labels. Alternatively, the image may capture a person's glove and a label of an item and make quantity determinations based on labels that are taken by the glove from the bin or box. In yet other embodiments, weight may be used to detect quantity.

Using the dimensions associated with an item (as pulled from the blockchain associated with the item, for example) and the weight of the item (as pulled from the blockchain associated with the item, for example), the unified tracking system may automatically create shipping labels for items that are ready to be shipped out. In some embodiments, a shipping information block may be added to the blockchain associated with the item and the unified tracking system label associated with the item may be used as the shipping label (i.e., the public courier service may utilize the label associated with the blockchain of the item (and may add additional information and consider additional information from the blockchain of the item is carrying out the shipping of the item.

Because the blockchain associated with a label provides transparency about the item, specialized shipping algorithms may be applied to automatically ensure that certain items (e.g., such as batteries or flammable liquids) are shipped via ground transportation and not via air transportation (where it is prohibited, for example) and that other items (e.g., such as time sensitive items) are shipped via faster air transportation and not via slower ground transportation (to protect against spoilage, for example).

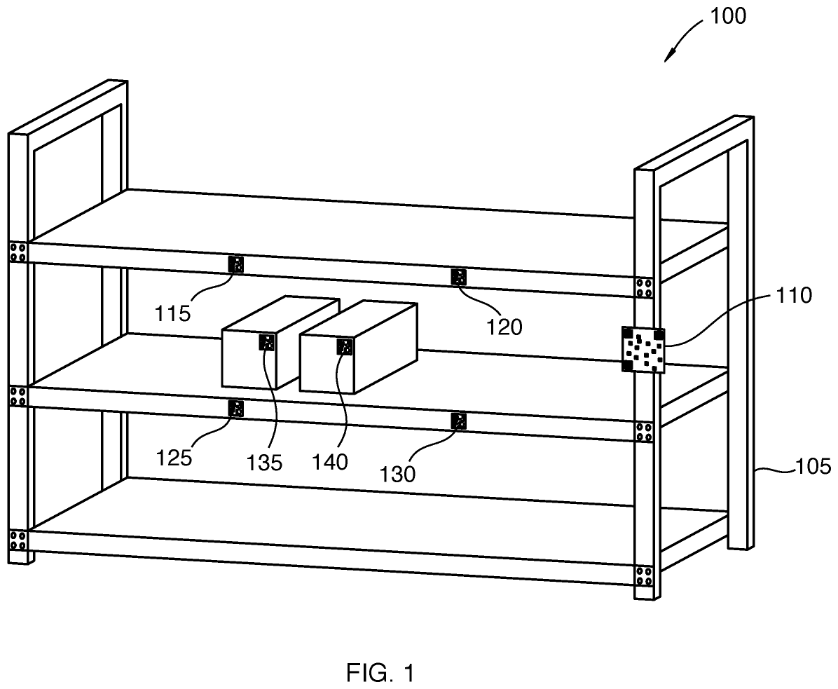

Turning now to the figures, FIG. 1 is a perspective diagram illustrating an embodiment 100 in which the described systems and methods may be used. In this embodiment, labels may be used to identify locations (as is the case of labels 110, 115, 120, 125, and 130, for example) as well as be used to identify boxes (as is the case of labels 135 and 140, for example). A shelf 105 may be affixed to a building (bolted to the floor, for example). A first label 110 is affixed to the shelf 105. The location of the first label 110 may be determined with reference to the building. For example, the location of the first label 110 may be determined by measuring a distance between the first label 110 and each of a first wall of the building, a second wall of the building, and the floor of the building to arrive at a 3D point in space with reference to the building (e.g., 130 feet from the first wall (e.g., north wall) of the building, 26.5 feet from the second wall (e.g., east wall) of the building, and 4.18 feet from the floor of the building).

One or more additional labels (e.g., 115, 120, 125, 130) may be affixed to the shelf 105. The location of each of these additional labels are determined with respect to and based on the known location of the first label 110. Due to the nature of the first label 110 being of a known size (e.g., having known dimensions), the first label 110 itself provides scale for determining locations in proximity to the first label 110. Based on a single image that includes the first label 110 and an additional label, the location of the additional label may be determined. For instance, based on the image that includes the first label 110 and additional label 115, an algorithm may determine (based on the size/scale provided by the first label 110, for example) the relative distances (in all viewable directions, for example) between the first label 110 and the additional label 115 (0.001 feet further north, 5.1 feet further east, and 0.9 feet higher from the floor than the first label 110. Based on this relative information, the algorithm determines that the location of the additional label is 129.999 feet from the first wall, 21.4 feet from the second wall, and 5.08 feet above the floor. Thus, the location of all additional labels in the second tier are based on a relative distance to the first label 110.

The shelf 105 includes 2 boxes, each of which including a label (e.g., 135, 140). The box labels may be in a third (or lower tier), which may determine location based on the tier immediately above as described herein. In this case, the location of the additional label 125 is known (based on reference to the first label 110, for example) and the relative distance/relationship between the additional label 125 and the box label 135 is determined based on the known size/dimensions of the additional label 125 and the box label 135 and the spatial relationship between the additional label 125 and the box label 135. Based on this spatial relationship, as discussed above, the algorithm determines the relative distance, from which the specific location in the building may be determined as discussed herein.

In this way, items may easily be located based on a relationship or series of relationships with lead back to a fixed location (e.g., the first label 110, with the location that is explicitly measured (using laser distance finders, for example). Because of the use of references, boxes may come and go, may be moved forward and back and/or left or right—with the updated location being easily discernable. These locations may be stored as an attribute in the appropriate blockchain of a different item or may be the genesis block of a unique blockchain for the location that has its own attributes and becomes a reference for the attribute location blocks.

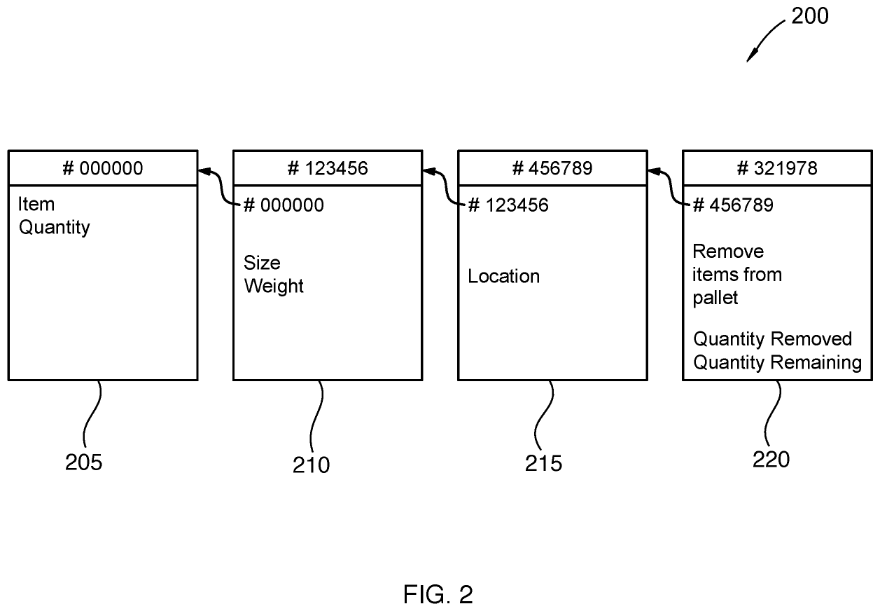

FIG. 2 is a block diagram illustrating a blockchain 200 that may be used in the described systems and methods. The blockchain includes a first block 205, a second block 210, a third block 215, and a fourth block 220. While only four blocks are illustrated, it is appreciated that each blockchain may have a nearly unlimited number of subsequent blocks in the chain.

The blockchain begins with a first (e.g., genesis) block 205 that includes a start identifier (e.g., #000000). The first block 205 does not follow another block but is itself the start of a new block chain. In one example, the first block 205 identifies the item that it is about. In some cases, as in the case of a pallet that includes sub items, the first block (or a subsequent block) may have a quantity value of sub items.

The second block 210 has a second identifier (e.g., #123456) and a reference to the prior block (e.g., the first block #0000000). In one example, the second block 210 include a size/shape/dimensions value and a weight value. For example, the weight of the item may be determined as the item is lifted by a pallet lift (e.g., forklift) and the size/shape/dimensions of the item may be determined by an algorithm (e.g., 3D modeling algorithm) based on images from a camera as the item is moved by the pallet lift. Accordingly, the size/shape/dimensions and weight may be determined at approximately the same time such that both values may be included in the same block (e.g., second block 210).

The third block 215 has a third identifier (e.g., #456789) and a reference to the prior block (e.g., the second block #123456). In one example, the third block 215 includes a location of the item. In some cases, the location may be determined based on the spatial relationship between a label of the item and a location label (e.g., label 125) as described with respect to FIG. 1.

The fourth block 220 has a fourth identifier (e.g., #321978) and a reference to the prior block (e.g., the third block #456789). In one example, the fourth block 220 includes an action that occurred on the item (e.g., remove subitems from an item, remove items from the pallet, for example). In addition to including the action, the fourth block 220 may identify the quantity removed from the item and/or the quantity remaining with the item (based on the quantity included in the first block 205, for example).

It is appreciated that each block has an identifier, and each identifier is unique in the blockchain. The requirement of unique identifiers is necessary to ensure that proper chaining of the blocks. The blockchain provides transparency to all of the attributes and details that may be of interest (e.g., item details, quantity, size, weight, location, actions, interactions with persons, interactions with processes, status, milestones, shipping information, and the like.

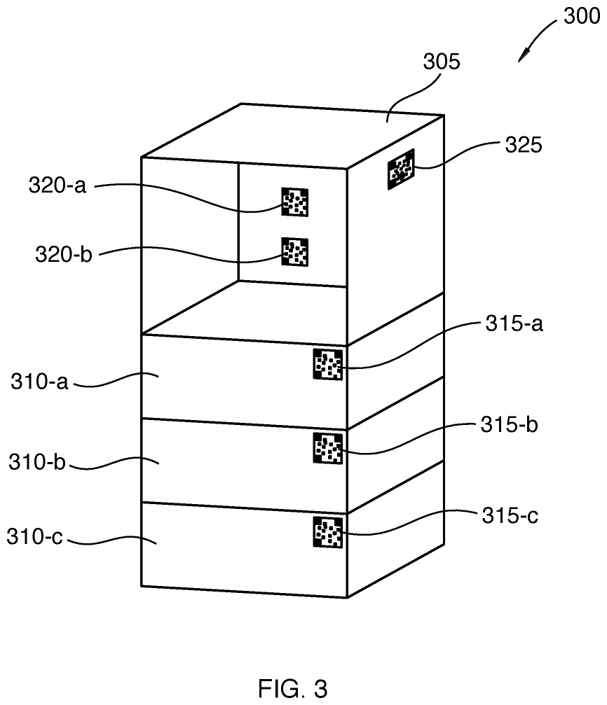

FIG. 3 is a block diagram illustrating an embodiment 300 illustrating automated quantity determination. A box 305, which is an item identified by label 325, may include multiple sub-items (e.g., 310-a, 310-b, 310-c). As illustrated, the box 305 may have capacity for five (5) sub-items. In some embodiments, the quantity of sub-items may be determined based on the visibility of labels and/or the lack of visibility of labels (as captured in an image of a camera, for example).

In one example, each sub item 310 may include a label 315. In the case that box 305 begins with a quantity of five (5) sub items and all five sub-item labels 315 are visible, then the quantity of five is confirmed. If two sub-items are taken, then only three sub-items 310-a, 310-b, 310-c are remaining, which leaves only three sub-item labels 315-a, 315-b, 315-c. Based on an image capturing the three-remaining label 315a, 315-b, 315-c (and not capturing the previously seen other sub-item labels, for example), then a quantity of three sub-items is determined/confirmed.

Additionally, or alternatively, quantity determinations may be based on a previously non-visible label becoming visible (such that it is captured in an image by a camera, for example). In some embodiments, the back of the box (what would be behind the sub-items, for example) may include one or more labels 320 (as shown) that become visible when a sub-item 310 is removed. In some cases, there is a one-to-one (1:1) relationship between labels 320 and sub-items such that quantity may inversely be determined based on how many label 320 are visible. In the example illustrated, labels 320-a and 320-b are visible because two (2) sub-items are removed (leaving a quantity of three (3) out of a total of five (5) as the remaining quantity). Accordingly, labels that were previously visible and then no longer visible can be used to determine quantity as well as previously non-visible labels that become visible can be used to (inversely, for example) determine quantity.

In some cases, a reorder action may be triggered automatically based on a determined quantity. For example, a reorder order can automatically be made when a quantity of 2 is determined. It is appreciated that the reorder quantity may dependent upon reorder time, expected usage, and the like.

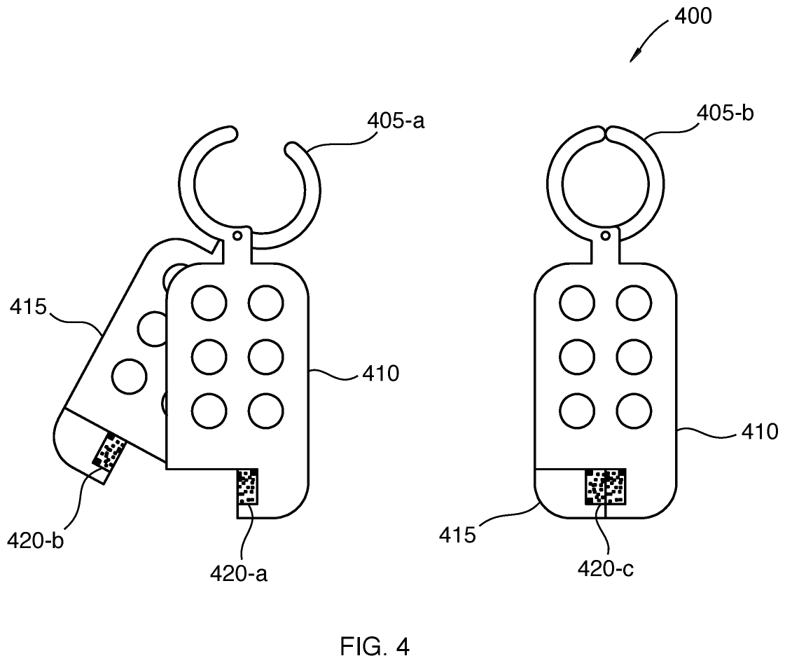

FIG. 4 is a perspective diagram illustrating a safety lockout hasp 400 that utilizes the described systems and methods. The safety lockout hasp 405 has an open configuration illustrated in safety lockout hasp 405-a and a closed configuration illustrated in safety lockout hasp 405-b. The safety lockout hasp 405 includes two planar sections, an upper planar section 410, and a lower planar section 415. These planar sections include holes that line up so as to be secured by a lock when in the closed configuration (to provide the lock out tag out functionality, for example).

As illustrated, the upper planar section 410 may include a first portion (e.g., half) of a label 420-a and the lower planar section 415 may include a second portion (e.g., half) of a label 420-b. When the safety lockout hasp 405-a is in the open configuration the label 420 is incomplete unreadable (e.g., non-visible). On the hand, when the safety lockout hasp 405-b is in the closed configuration the upper planar section 410 and the lower planar section 415 are aligned, which align the holes (for proper lock out tag out functionality, for example) and align the first portion of the label 420-a and the second portion of the label 420-b to create a complete (e.g., readable) label 420-c.

Because the label 420-c only becomes visible (e.g., readable) when the safety lockout hasp 405-b is properly closed, confirmation of closure can be automatically recorded and/or confirmed when the label 420-c is visible in an image captured by a camera. Based on the visibility of one or more labels (e.g., label 420-c) the configuration of certain environments (e.g., lock out tag out environments) may be automatically tracked and verified based on the visibility of particular (and/or a combination of particular) labels (e.g., label 420-c).

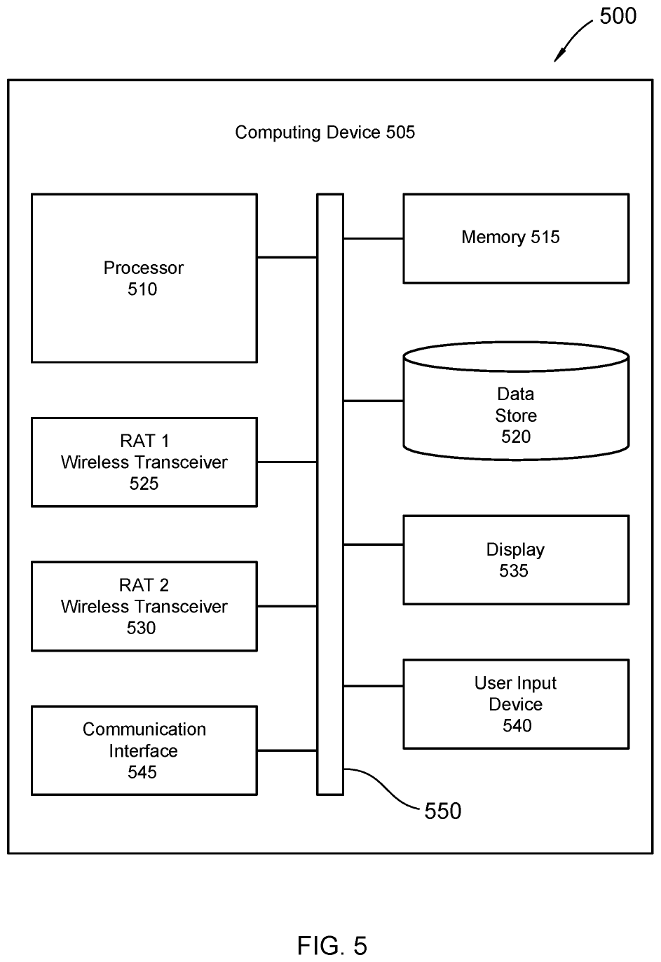

FIG. 5 is a block diagram of a computing device 500 for implementing the described systems and methods. In some embodiments, the server described herein (that implements the unified tracking system and the various algorithms described herein, for example) may be examples of the computing device 505.

The computing device 505 includes a processor 510 (including a general-purpose processor and one or more application specific processors, for example), a wireless transceiver 525 for communicating via a first RAT (e.g., Wi-Fi, Bluetooth, 3G, 4G, LTE, 5G-NR, and/or Lora WAN), an optional wireless transceiver 530 for communicating via a second RAT (e.g., Bluetooth, Wi-Fi), a communication interface 545 (e.g., serial interface, peripheral component interconnect express), a memory 515 (e.g., random access memory (RAM), non-volatile RAM (NVRAM)), data store 520 (e.g., hard disk drive, solid state disk), an optional display 535 for interfacing with a user, a user input device 540 (e.g., touch input, mouse, keyboard, pen input), and an interconnect or bus 550 for interconnecting each of the components 510-540.

In some embodiments, the memory 515 and/or the data store 520 (each being a non-transitory storage medium, for example) may store instructions that are executable by the processor 510 to implement the systems and methods described herein. For example, the instructions may be executable by the processor 510 to implement any of the methods (or algorithms) described herein.

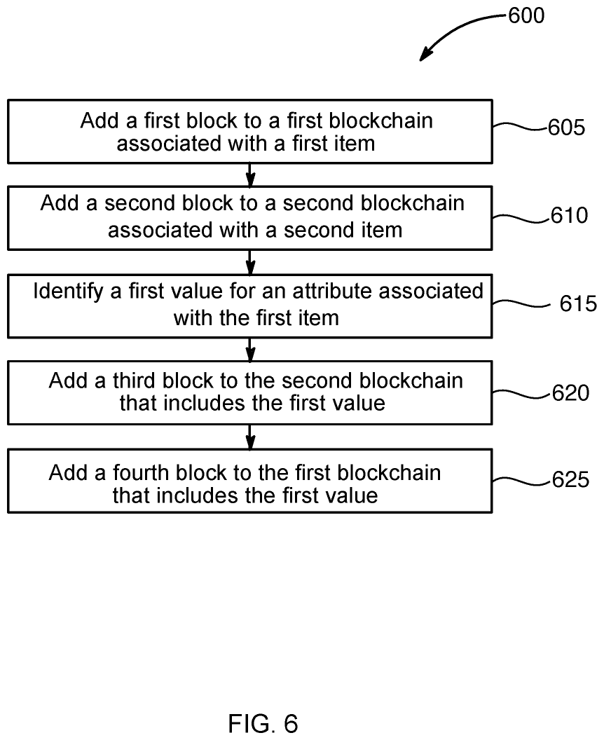

FIG. 6 is a flow diagram illustrating one example of a method 600 for tracking items. The method 600 may be implemented by a computing device 505 or an application specific processor (e.g., processor and memory) included within a device.

At 605, a first block is added to a first blockchain associated with a first item. At 610, a second block is added to a second blockchain associated with a second item. At 615, a first value for an attribute associated with the first item is identified based on an association with the second item. At 620, a third block is added to the second blockchain, where the third block includes the first value for the attribute of the first item and a reference to a block in the first blockchain. At 625, a fourth block is added to the first blockchain, where the fourth block includes the first value for the attribute of the first item and a reference to a block in the second blockchain.

The systems, devices, and methods described herein have been described with reference to various specific and preferred embodiments and techniques. Nevertheless, it is understood that many variations and modifications may be made while remaining within the spirit and scope of the describes systems, devices, and methods.

1. A method for tracking items by a computing device, comprising:
capturing a first image that includes a first label via a first camera, wherein the first label comprises a first identifying code that is associated with a first item;
adding a first block to a first blockchain associated with the first item;
capturing a second image that includes a second label via a second camera, wherein the second label comprises a second identifying code that is associated with a second item;
adding a second block to a second blockchain associated with the second item;
identifying a first value for an attribute associated with the first item based on an association with the second item;
adding a third block to the second blockchain, wherein the third block includes the first value for the attribute of the first item and a reference to a fourth block in the first blockchain; and
adding the fourth block to the first blockchain, wherein the fourth block includes the first value for the attribute of the first item and a reference to the third block in the second blockchain.

2. (canceled)

3. The method of claim 1, further comprising:
adding a fifth block to a third blockchain associated with a third item;
identifying a second value for the attribute associated with the first item based on an association with the third item;
adding a sixth block to the third blockchain, wherein the sixth block includes the second value for the attribute of the first item and a reference to a seventh block in the first blockchain; and
adding the seventh block to the first blockchain, wherein the seventh block includes the second value for the attribute of the first item and a reference to the sixth block in the third blockchain.

4. The method of claim 3, further comprising:
determining a difference between the second value for the attribute and the first value for the attribute;
triggering an alert when the difference between the second value for the attribute and the first value for the attribute exceeds a threshold; and
adding an eighth block to the first blockchain, wherein the eighth block includes information about the alert.

5. The method of claim 3, wherein the fourth block includes a first timestamp for the first value and wherein the seventh block includes a second timestamp for the second value, and wherein the second timestamp is after the first timestamp.

6. The method of claim 1, wherein the fourth block includes a reference to the first block, and wherein the third block includes a reference to the second block.

7. The method of claim 1, wherein the item is one of a product, a piece of equipment, a raw material, an action, a person, and a document.

8. The method of claim 1, wherein the attribute is one of a weight, a size, a location, a temperature, a duration, a status, an event, a transaction, and a financial parameter.

9. The method of claim 1, further comprising:
identifying the first item based on the first identifying code; and
identifying the second item based on the second identifying code.

10. The method of claim 9, wherein the first identifying code and the second identifying code are electronically identified from the first image and the second image.

11. A device for tracking items, comprising:
at least one camera;
a processor;
memory in electronic communication with the processor; and
instructions stored in the memory that when executed by the processor cause the processor to:
identify a first label in a first image captured by the at least one camera, wherein the first label comprises a first identifying code that is associated with a first item;
add a first block to a first blockchain associated with the first item;
identify a second label in a second image captured by the at least one camera, wherein the second label comprises a second identifying code that is associated with a second item;
add a second block to a second blockchain associated with the second item;
identify a first value for an attribute associated with the first item based on an association with the second item;
add a third block to the second blockchain, wherein the third block includes the first value for the attribute of the first item and a reference to a fourth block in the first blockchain; and
add the fourth block to the first blockchain, wherein the fourth block includes the first value for the attribute of the first item and a reference to the third block in the second blockchain.

12. (canceled)

13. The device of claim 11, wherein the instructions are further executable by the processor to:
add a fifth block to a third blockchain associated with a third item;
identify a second value for the attribute associated with the first item based on an association with the third item;
add a sixth block to the third blockchain, wherein the sixth block includes the second value for the attribute of the first item and a reference to a seventh block in the first blockchain; and
add the seventh block to the first blockchain, wherein the seventh block includes the seventh value for the attribute of the first item and a reference to the sixth block in the third blockchain.

14. The device of claim 13, wherein the instructions are further executable by the processor to:
determine a difference between the second value for the attribute and the first value for the attribute;
trigger an alert when the difference between the second value for the attribute and the first value for the attribute exceeds a threshold; and
add an eighth block to the first blockchain, wherein the eighth block includes information about the alert.

15. The device of claim 13, wherein the fourth block includes a first timestamp for the first value and wherein the seventh block includes a second timestamp for the second value, and wherein the second timestamp is after the first timestamp.

16. The device of claim 11, wherein the fourth block includes a reference to the first block, and wherein the third block includes a reference to the second block.

17. The device of claim 11, wherein the item is one of a product, a piece of equipment, a raw material, an action, a person, and a document.

18. The device of claim 11, wherein the attribute is one of a weight, a size, a location, a temperature, a duration, a status, an event, a transaction, and a financial parameter.

19. The device of claim 11, wherein the instructions are further executable by the processor to:
identify the first item based on the first identifying code; and
identify the second item based on the second identifying code.

20. The device of claim 19, wherein the first identifying code and the second identifying code are electronically identified from the first image and the second image.
